(19) United States
(12) Patent Application Publication
(10) Pub. No.: US 2017/0159624 A1
(43) Pub. Date: Jun. 8, 2017

(54) FUEL TANK CLEANING ARRANGEMENT

(71) Applicant: MTU FRIEDRICHSHAFEN, Friedrichshafen (DE)

(72) Inventor: Wolfgang REISCHMANN, Argenbuehl (DE)

(73) Assignee: MTU FRIEDRICHSHAFEN GMBH, Friedrichshafen (DE)

(21) Appl. No.: 15/438,838

(22) Filed: Feb. 22, 2017

Related U.S. Application Data
(63) Continuation-in-part of application No. PCT/EP2015/001600, filed on Aug. 4, 2015.

(30) Foreign Application Priority Data
Oct. 28, 2014 (DE) 10 2014 016 457.8

(51) Int. Cl. F02M 37/22; F02M 37/04; B01D 35/26; B01D 35/00; B01D 35/143

(52) U.S. Cl. CPC F02M 37/22; B01D 35/005; B01D 35/143; B01D 35/26; F02M 37/04

(57) ABSTRACT

In a tank cleaning arrangement for cleaning liquid fuel stored in a fuel tank, the fuel is circulated from various selectable outlet areas to various selectable inlet areas provided on the tank via a conduit system including circulating pumps and filters arranged at various locations. At least one circulating pump is driven mechanically by an engine associated with the tank cleaning arrangement, whereby the tank cleaning arrangement is shut down automatically when the engine is shut down, so that a control as well as a separate drive system for the at least one circulating pump can be omitted. Also a combustion engine with such tank cleaning system is and an operating method for the tank cleaning arrangement are disclosed.

This is a Continuation-In-Part application of pending international patent application PCT/EP2015/001600 filed Aug. 4, 2015 and claiming the priority of German patent application 10 2014 016 457.8 filed Oct. 28, 2014.

### BACKGROUND OF THE INVENTION

The invention concerns a tank cleaning arrangement for the cleaning of liquid fuel stored in a fuel tank including a circulation conduit system via which, with the fuel tank installed, the fuel is circulated from at least one outlet of the fuel tank to an inlet of the fuel tank with at least one fuel filter arranged in the circulation conduit system, and at least one circulation pump arranged in the circulation conduit system. Furthermore, the invention concerns a system comprising a fuel tank with a tank cleaning arrangement. In addition, the invention concerns an internal combustion engine with a fuel tank and a tank cleaning arrangement.

Problems with the fuel do not only occur in connection with motor vehicles but for example also in connection with ships or electric power generation plants, in particular in regions where only fuel of bad quality, that is fuel with contaminations is available. If, in this case, no tank cleaning arrangement would be present for removing the contaminations from the fuel permanently, a motor filter, which cleans the fuel before it is supplied to a fuel injection system, would reach its filtering limits at an earlier point in time, so that the motor filter would have to be exchanged more frequently during operation of the motor or combustion engine. This also results in a more frequent shut-down of the combustion engine and, furthermore, the engine may be damaged because of the bad fuel quality supplied to the engine when the filter change is neglected. Consequently, the use of a fuel tank cleaning arrangement also results in an increased life expectancy for the combustion engine.

At the present time, tank cleaning arrangements are known wherein the circulation of the liquid fuel is ensured by an electric energy supply. Herein, the liquid fuel stored in a tank cam be circulated for example by an electric pump which is provided with a filter, so that, on one hand, the fuel is cleaned and, on the other, deposits and contaminants are removed. To this end, at the respective location of the tank cleaning arrangement, an electric power supply system must be present. In addition, it is necessary for the operation of such a tank cleaning arrangement that a control system is provided. For example, in a motor vehicle or a ship wherein the engine is shut down and power can be supplied only by batteries, it may become necessary that the tank cleaning arrangement is shut down by a separate control or by the engine control system in order to prevent total discharge of the batteries. However, to provide an additional control system or a control integrated into the engine control, which controls the operation of the tank cleaning arrangement, is involved and expensive. In addition, the servicing needs are increased since also the control of the tank cleaning arrangement needs to be examined at predetermined intervals.

It is the principal object of the present invention to provide for a tank cleaning arrangement an improved or at least an alternative arrangement which can be operated independently of an electric power supply system.

### SUMMARY OF THE INVENTION

In accordance with the invention, a fuel tank cleaning arrangement for cleaning liquid fuel stored in a fuel tank is provided with a circulation system via which, when installed in connection with the fuel tank, the fuel is circulated from an outlet point on the fuel tank to at least one inlet point of the fuel tank. Herein, at least one fuel filter and a circulation pump or pumps are arranged in the circulation system and at least one circulation pump is driven mechanically.

In this way, advantageously, with the mechanically driven circulation pump, independency from the electric power supply can be ensured. Also the need for a complicated and expensive control and the installation of power supply lines for supplying electric energy to the circulation pump is omitted. With such an arrangement, also batteries possibly used for driving pumps cannot be excessively discharged since the circulation pump does not need to be operated by an electric motor when for example the control system fails or an appropriate control system is not present. As a result, operational security can be improved and maintenance costs and manufacturing costs of the tank cleaning arrangement can be reduced.

If for example the circulation pump is directly mechanically connected to the combustion engine so as to be driven thereby, it is ensured that the circulation pump is running only when also the combustion engine is running. A complicated control system is not needed in this case.

A fuel tank is a device in which fuel is stored either for supplying the fuel to a combustion engine or only for storing it for a certain time for example in large fuel tanks or in central fuel storage facilities. A fuel tank may be designed as an integral containment or it may be segmented or it may be a fuel farm comprising several individual fuel tanks which may be interconnected by pipe lines as it is currently done for example in the area of house heating systems. Such a fuel tank may also be used in connection with fracking plants wherein, on one hand, the liquid fuels are stored in the fuel tanks and, on the other hand, the pumped liquid fuels are also used for operating the combustion engines of the fracking plant.

In particular, with regard to the example of the fracking plant, such a separate tank cleaning arrangement is advantageous since, on one hand, the pumped fuel quality can be improved and, as a result, a higher sales price can be achieved and, on the other hand, the pumped fuel can be fed at location as fuel to operate the machinery so that an additional supply of fuel from the outside is not necessary.

Fuel tank arrangements provided with such tank cleaning arrangements may also be advantageous in connection with marine applications since a uniform fuel quality can be provided for use by the combustion engines independently of the fuel quality supplied to the respective tank, and, in case of a fuel transport, the fuel quality can be improved during the transport.

Consequently, such tank cleaning arrangements can be used for example in vehicles, ships, tankers, fracking plants, rail vehicles, city block heating plants, fuel storage installations, house heating systems or similar.

A liquid fuel comprises hydrocarbons which are liquid at room temperature, such as cerosin, motor petroleum, petroleum, gasoline, Otto engine fuel, two-cycle engine mixtures (gasoline with oil additives) gasoline-benzene mixtures, Diesel fuel, biodiesel, XtL-fuel, GtL fuel (gas to liquid) emulsion fuel, light gasoline, alkyl gasoline, ethanol fuel, bio-ethanol, cellulose ethanol, butanol, bio-butanol, methanol, plant oil, heavy oil, benzene, gas-oil.

Such a fuel tank has a main outlet point, via which the fuel is removed from the fuel tank for further use, and a main inlet point via which the fuel is introduced into the fuel tank. It is possible that several main outlet points and/or several main inlet points are provided. It is also possible that the main outlet points and the main inlet points are identical. In the case of a fuel tank of a combustion engine therefore the main outlet point is the location at the tank via which by means of a supply line the fuel is conducted to the combustion engine. Generally, the supply line includes a pump and at least one engine filter.

A circulation conduit system is understood to be a conduit system via which fuel is circulated in the fuel tank. It is also possible that the circulation conduit system in part also serves other functions. It is for example possible that the fuel supply line to the engine forms in part a section of the circulation conduit system so that over that part of the circulation conduit system or, respectively, the supply line fuel is supplied to the engine and fuel is also circulated. Consequently, the circulation system includes those conduit sections via which also fuel is circulated. Consequently, the conduit sections via which fuel is circulated are considered part of the circulation system. An exception hereof are the supply line sections after the engine filter and also the motor filter which, according to the above definition, are not part of the circulation system.

An outlet point or, respectively, an inlet point is the point where fuel is removed or respectively supplied, however, limited to the circulation of the fuel in a fuel tank. Herein, the main outlet point and the main inlet point may be an outlet location or, respectively, an inlet location where the fuel is removed from the tank for the purpose of circulation or, respectively, is supplied to the main inlet also for the purpose of circulation.

An installation location is understood to mean the design position of the tank cleaning arrangement during operation in connection with a fuel tank and/or a combustion engine.

A circulating pump is a pump by which fuel can be circulated in the fuel tank. As circulating pumps, centrifugal pumps, displacement pumps, axial pumps, diagonal pumps, radial pumps, bellows pumps, membrane pumps, scroll compressors, rotational piston pumps, gear pumps, worm gear pumps, transport worm gears, hydraulic ram pumps, impeller pumps, chain pumps, piston pumps, axial piston pumps, stroke piston pumps, pneumatic-hydraulic pressure converters, radial piston pumps, annular piston pumps, hose pumps, screw spindle pumps, sinus pumps, gear belt pumps or similar may be employed.

A fuel filter is understood to be a filter by which impurities can be at least partially removed from the fuel. Herein, the fuel filter may be in the form of a floating material filter (depth filter or surface filter, back washable) parallel filter, water separator, coarse filter, centrifugal filter (separator) cascade filter, plastic filter with or without back-flushing.

A mechanically driven circulation pump is understood to be a circulation pump which is driven mechanically. As a result, such a circulation pump does not need an electric energy supply but a mechanical power supply for example via a gear box, a toothed belt, a V-belt or similar.

Furthermore, the tank cleaning arrangement may include at least a first fuel filter arranged in the circulation system in the flow direction of the fuel ahead of at least one circulation pump. Such a first fuel filter is used advantageously for a coarse cleaning of the fuel and is arranged in the flow direction of the fuel after the circulation pump so that the circulation pump is largely protected from being damaged by impurities.

Herein the first fuel filter may be in the form of a settling chamber, a coarse filer, a water separator, a parallel filter or similar. If, additionally, it is provided with back-flushing the service requirements with respect to the first fuel filter can be substantially reduced.

Further, at least a second fuel filter may be provided in the circulation system in the flow direction of the fuel after at least one circulation pump for the removal of finer contaminants from the fuel.

Such a second fuel filter may be in the form of a change-over filter, in particular a pendulum change-over filter so that by simply exchanging the second filter a continuous cleaning of the fuel is ensured. Advantageously, such a second filter does not necessitate a shut-down of the combustion engine as it is necessary in connection with an engine filter, where the mechanical drive for the circulation pump has to be shortly shut down. This results advantageously in longer operating periods of the combustion engine even with needed filter exchanges in the tank cleaning arrangement and change-over possibilities at more flexible time intervals. But it is also possible to use switch-over filter heads with which for a filter exchange one filter can be switched inactive but such switchover filter heads are expensive and they require at least two filters.

Furthermore, a sensor may be provided in a circulation conduit system by which the contamination of the fuel or the pressure in the system can be detected.

It is advantageous if different actions can be initiated by such a sensor, for example an exchange of a filter, a shut-down of the tank cleaning arrangement, a change of the extraction location or similar, depending on where the sensor is positioned in the circulation conduit system in the flow direction of the fuel and what kind of contamination degree is detected.

If a sensor is arranged for example ahead of at least a first fuel filter, it is possible to detect at this location, for example depending on the degree of contamination, whether the fuel is sufficiently cleaned or whether for example the contamination ahead of the first fuel filter is such that the first fuel filter could be damaged so that, in the second case, a shut-down of the tank cleaning arrangement might be necessary.

If at least one sensor is arranged for example after a first filter it is possible to judge, for example in co-operation with the detected degree of contamination ahead of the first fuel filter, the cleaning capability of the first fuel filter. In this way disturbances and faulty functions of the first fuel filter can be detected.

If at least one sensor is arranged in front of at least one circulation pump, the circulation pump may be protected if, with excessive contamination detected, the circulation pump is shut down.

If at least one sensor is arranged integrated into at least one circulation pump, advantageously the number of system components can be reduced and the circulation pump can be provided with an integral pump protection.

If at least one sensor is arranged ahead of at least one second fuel filter, again the degree of contamination of the fuel ahead of the second fuel filter can be detected in order to determine from the degree of contamination ahead of the second fuel filter whether the fuel quality is sufficient to permit omitting a further filtering procedure in the respective second fuel filter. In this case, the fuel could be withdrawn from another outlet point of the tank cleaning arrangement.

If at least one sensor is arranged after at least a second fuel filter, for example taking into consideration the degree of contamination ahead of the second fuel filter, the filtering capability of the second fuel filter or, respectively, the aging state of the second fuel filter can be determined and, by means of sensors arranged in this way, the need for an exchange of the respective fuel filters can be detected.

In addition, at least one outlet may be arranged in the area of the tank bottom. This is advantageous because, with such an outlet, fuel can be sampled from an area in which, in particular with a longer storage period, the largest concentration of most contaminations can be expected. If fuel for the cleaning operation is taken from the area of the tank bottom, an expensive cleaning of the tank bottom after an extended use of the fuel tank may not be needed since contaminations can be removed continuously from the area of the tank bottom.

An area of the tank bottom is understood to be an area which comprises 30% of the height of the tank from the bottom thereof, in particular up to 15% of the height, possibly up to 12% of the tank height and, for example up to 10% of the height of the tank

If an outlet is arranged in the area of the main outlet location and, particularly, if at least one of the outlet locations is the main outlet location, advantageously, fuel can be circulated which comes from an area from which fuel is mainly withdrawn. With a possible use of sensors in this area, alternatively or cumulatively the contamination in the area of the main outlet can be detected.

If at least one outlet is arranged in the area of the main fuel inlet area, for example after supplying fresh fuel to the tank which fuel possibly includes a greater amount of contaminations, it is then possible to withdraw fuel from the fuel inlet area for circulation and purification for a certain time in order to remove a good part of the contamination from the fuel tank before the contamination is distributed across the tank or, respectively, or can settle on the tank bottom.

Herein, the area of the main outlet and the area of the main inlet comprise an area which is determined in each case by the connecting line between the main outlet and the main inlet. As a result, the area of the main outlet is the area between an imaginary surface extending normal to the connecting line and the main outlet, whereas the area of the main inlet is the area which is arranged between an imaginary surface extending normal to the connecting line and the main inlet area. Herein the surface extending in each case normal to the connecting line with less than 30% of the connecting line may be positioned starting from the main outlet location or the main inlet location. It is also possible hat in each case the surface area extending normal to the connecting line is positioned starting from the main outlet location or the main inlet location by less than 20%, particularly less than 15%, possibly less than 12% and for example less than 10% of the connecting line.

Furthermore, at least one outlet location may be provided in an intermediate area between the area of the main outlet and the main inlet area. Advantageously, with the presence of an outlet area arranged in the intermediate area, also the intermediate area may be cleaned continuously by the removal of contaminations.

The intermediate area is to be understood to be the area between the two imaginary surface areas extending normal to the connecting line, wherein the intermediate area may comprise more than 40% of the connecting line. It is also possible that the intermediate area comprises more than 50%, in particular more than 60% and possibly more than 70% and for example more than 80% of the connecting line. In this connection it is further conceivable that the intermediate area is further segmented and includes more than one outlet so that the tank cleaning arrangement is in the direction of the connecting line between the main outlet location and the main inlet location divided not only into the main outlet area and the main inlet area but also into one or more intermediate areas.

Furthermore, in the installation at least one inlet location may be arranged in the area of the top end of the fuel tank. Advantageously, with such an arrangement, at least one inlet area can be established in the area of the top of the fuel tank, so that in the fuel tank a contamination gradient can be established which increases from the top end of the tank to the bottom end of the tank. This is achieved in that clean fuel is supplied at the top end of the tank and, over time, contamination settles toward the tank bottom.

Herein, the area of an upper end of the tank may extend, starting at the top of the tank up to 30% of the tank toward the tank bottom. It is also conceivable that the area of the tank top starting from the top end of the tank extends toward the bottom of the tank by 20% of the height of the tank, possibly up to 15% of the height of the tank, in particular up to 12% of the height of the tank and possibly up to 10% of the height of the tank.

If in the installed position at least one inlet area is provided in the middle of the fuel tank the fuel can be returned to the fuel tank without large height differences, so that, also with the tank filled only halfway, an excessive mixing and gas bubble formation by the incoming fuel can be avoided.

Herein, an area in the middle of the tank is to be understood to be the area of the fuel tank which is between the top area of the tank and the bottom area of the tank. Consequently, the middle area of the tank may comprise 60% of the height of the tank. It is also possible that the area of the middle of the tank comprises more than 60% of the tank, in particular more than 65% of the height of the tank, possibly more than 70% or more than 75% and for example more than 80% of the height of the tank.

If in the area of a main outlet of the fuel tank at least one inlet is arranged, advantageously in the area of the main inlet location, the contamination gradient of the fuel can be successively reduced by liquid displacement and the introduction of clean fuel. It is advantageous if fuel for a combustion engine is taken for example out of the main outlet, whereby a lower deposition of contaminations in the engine filter can be achieved.

If at least one inlet location is arranged in the area of a main inlet of the fuel tank, the fuel can be cleaned also in this area.

With the arrangement of at least one inlet in the intermediate area between the area of the main outlet and the area of the main inlet, advantageously decontaminations can be removed successively during the storage of the fuel also from the intermediate area or, respectively, the degree of contamination in the intermediate area can be reduced.

If during operation of the tank cleaning arrangement the removal of fuel is transferred from the main outlet successively toward the main inlet area, furthermore an increasing contamination gradient toward the main inlet area can be established.

Furthermore, the fuel tank may be in a segmented form. Advantageously, with such a segmented design, the fuel tank can be divided into several segments which can each separately be cleaned. As a result, in the direction of the segmentation a contamination gradient can be provided, with a lowest degree of contamination preferably in the area of the main outlet and the highest degree of contamination in the area of the main inlet. Furthermore, it is also conceivable that, as a result of the segmentation, the tank bottom area is essentially freed from contaminations not only in the outlet area but in an area extending over several outlet areas.

Herein, a fuel tank is considered to be a tank which comprises for example several smaller tanks which are fluidically interconnected so that the fuel can be mixed throughout the individual tanks. It is furthermore conceivable that a tank segmentation can be achieved in an integrally formed tank by separating plates, possibly perforated intermediate plates, so that the intermediate plates reduce mixing in the direction of the segmentation. It is also conceivable that a segmented tank has a special form so that individual liquid layers intermix only slightly in both, the horizontal as well as the vertical directions. This is the case in particular in connection with large fuel tanks which are so large that only little mixing occurs horizontally as well as vertically.

Furthermore, at least on tank segment of the fuel tank can include an outlet area and an inlet area. Advantageously, with such a segmented design, wherein at least one, and particularly each, tank segment includes an outlet area and an inlet area, the fuel of a tank segment can be cleaned separately and possibly independently of other tank segments in a predetermined time interval. In this way, advantageously any desired contamination gradient across a tank can be established. It is for example conceivable that, in the area of the tank segment in which the main outlet area is arranged, there is a very high fuel quality, whereas in the main inlet area, the contamination degree is reduced only over a longer storage period.

In a further aspect of the invention a combustion engine with a tank cleaning arrangement as described above is proposed, wherein at least one circulation pump of the tank cleaning arrangement as described above is driven mechanically by the combustion engine.

It is advantageous that, by coupling the circulation pump with the combustion engine, a functional coupling can be achieved Without the need for further separate or integrated control devices for controlling the tank cleaning arrangement. Therefore, when the combustion engine is shut-down also the tank cleaning arrangement is shut-down and there is no need to monitor for example whether there is sufficient energy available for further operation. In addition filters in the tank cleaning arrangement can be changed whenever the combustion engine is shut down. This however is not absolutely necessary since the tank cleaning arrangement can be designed so that it can easily be uncoupled from the combustion engine by simple design features, whereby, also with the combustion engine running, the circulation pump can be shut down and the filters of the tank cleaning arrangement can be exchanged without the need for providing the tank cleaning arrangement with a switch-over filter system.

In this connection, a combustion engine is considered to be a piston engine, a gas turbine or similar.

Further, at least one circulating pump may be arranged in an aggregate carrier of the combustion engine. With the presence of an aggregate carrier, a mechanical coupling arrangement may be provided on the combustion engine for driving the circulation pump. As a result, in this case, with a very simple design feature, a combustion engine can be provided with a mechanically driven tank cleaning arrangement.

Herein, an aggregate carrier is to be understood to be for example a wheel box of the combustion engine, that is a console into which aggregates such as pumps or other mechanically driven components can be inserted in such a way that the aggregates can be driven by the combustion engine. Herein the mechanical drive can also be provided without aggregate carrier, for example via a belt drive, by engine oil, by the cooling water or by compressed air.

In accordance with another aspect of the invention, an operating method for a tank cleaning arrangement for example as described above, is provided wherein, during filling of the tank, the fuel is circulated between an outlet arranged in the area of the main outlet and an inlet arranged in the area of the main inlet.

Advantageously, in such an operating state it can be ensured that during the filling process the fuel in the area of the main outlet, from which for example the fuel for the combustion engine is taken, has the best possible quality and that is also true and this is also true during filling of the tank with low-quality fuel.

Furthermore, with this operating method, immediately upon fill-up, fuel can be circulated for a predetermined period between an outlet arranged in the main outlet area and an inlet arranged in the main inlet area.

It is advantageous if the fuel is circulated until a good enough fuel quality in the area of the main outlet is ensured. Accordingly, the predetermined period may be several hours, several days, several weeks or several months depending on the size of the fuel tank and the capability of the tank cleaning arrangement.

Furthermore, with the operating method, after a predetermined period of time, the fuel can be circulated from an outlet arranged in the main outlet area or an outlet arranged in the intermediate area or an outlet arranged in the main inlet area to an inlet arranged in the main outlet area.

With such a fuel circulation for example the area of the tank bottom can be cleaned successively without lowering the fuel quality in the area of the main outlet. In addition, with such an operating method, the quality of the fuel in the area of the main outlet can be maintained while the areas arranged successively after the main outlet location or, respectively, the tank segments successively following in the direction toward the main inlet area experience an increase of the fuel quality.

Furthermore, with the operating method the respective outlet areas and/or the respective inlet areas via which the fuel is circulated, cane be selected depending on the contamination of the circulated fuel.

Advantageously, with such a control of the respective outlet locations and inlet locations, any particular degree of contamination or, respectively, contamination gradient can be established in the individual areas of the fuel tanks or, respectively, tank segments so that, with a sufficiently good quality of the fuel in a respective area or, respectively, segment of the tank, further filtering which does not result in a desirable improvement of the fuel quality can be prevented. In this way, the tank cleaning arrangement can be operated efficiently and at reasonable expense for cleaning a part of the fuel tank or the whole content of the fuel tank.

The invention will become more readily apparent from the following description of a particular embodiment thereof described below with reference to the accompanying drawings.

### BRIEF DESCRIPTION OF THE DRAWINGS

The drawings show schematically in:

FIG. 1: a tank cleaning arrangement including a fuel tank and a combustion engine, and in

FIG. 2: an aggregate carrier of a combustion engine.

### DESCRIPTION OF A PARTICULAR EMBODIMENT

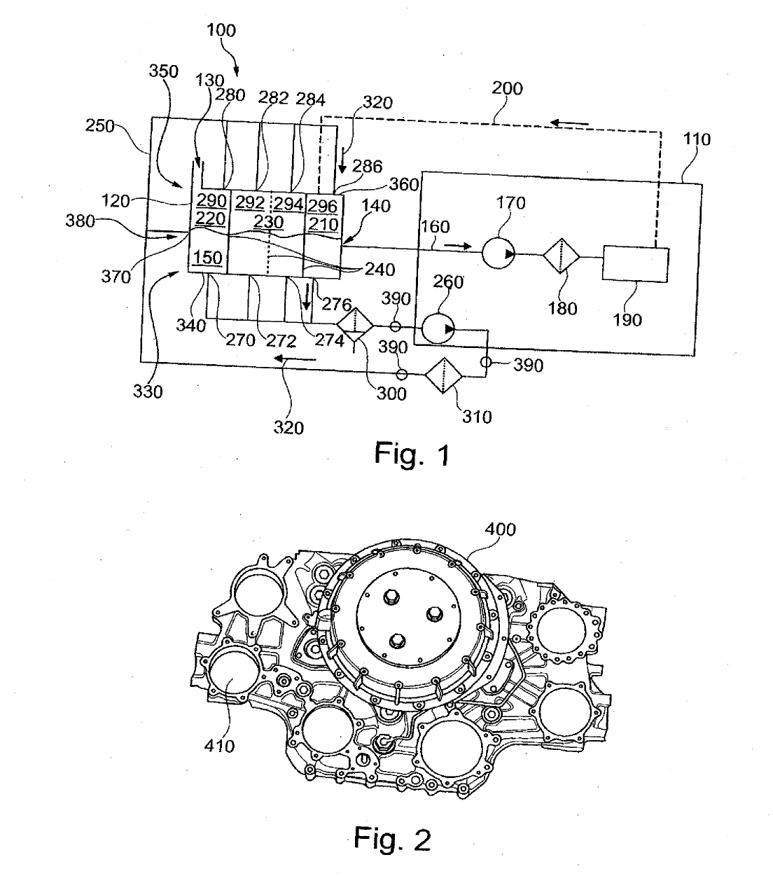

As shown in FIG. 1 a tank cleaning arrangement 100 can be provided in the form of a combination of a combustion engine 110 with a fuel tank 120.

Herein the fuel tank may have a main inlet 130 and a main outlet 140. The liquid fuel 150 stored in the fuel tank 120 can for example be used for operating the combustion engine 110 so that fuel 150 can be supplied to the combustion engine 110 from the main outlet area 140 via a supply line 160. In the supply line 160 an engine fuel pump 170 and an engine filter 180 may be arranged. In this way, it can be ensured that only sufficiently filtered fuel 150 is supplied to an injection device 190 of the combustion engine 110. In addition, a return line 200 may be provided by way of which the excessive fuel 150 can be returned from the injection device 190 to the fuel tank 120. Preferably, the fuel 150 is returned to a part 210 of the main outlet 140. In this way, advantageously it is ensured that the clean returned fuel mixes to a lesser degree with the possibly contaminated fuel before it is again removed from the main outlet area 140 of tank and re-supplied to the combustion engine 110.

The fuel tank 120 can be divided at least into a section 210 next to the main outlet area and a section 220 next to the main inlet 130. An intermediate area 230 between the main outlet 140 and the area 220 next to the main inlet 130 can further be divided as shown in FIG. 1. Such a segmentation or, respectively division of the fuel tank 120 into different areas 210 220 230 are established for example by plates 240 which are installed in the fuel tank 120 and which may be perforated.

The tank cleaning arrangement 100 includes a circulation conduit system 250 and at least one circulation pump 260 by which the fuel 150 is circulated through the circulation conduit system 250. Herewith the fuel is withdrawn from the fuel tank 120 via the outlets 270, 272, 274, 276 and returned to the fuel tank 120 via the inlets 280, 282, 284, 286. If, as shown in FIG. 1, the fuel tank is segmented and, additionally, each tank element 290, 292, 294, 296 includes an outlet 270, 272, 274, 276 and an inlet 280, 282, 284, 286, the fuel tank 120 can be cleaned by such a cleaning arrangement segment by segment.

In the circulation conduit system 250 at least a first fuel filter 300 and a second fuel filter 310 may be arranged. Herein the first fuel filter 300 is arranged in the flow direction 320 of the fuel 150 ahead of the circulation pump 260, whereas the second fuel filter 310 is arranged in the flow direction 320 of the fuel 150 after the circulation pump 260. The first fuel filter 300 may be in the form of a water collector or a coarse filter whereas the second fuel filter 310 may be a fine material filter or, respectively, it may be in the form of an engine filter. In FIG. 1, the circulation pump 260 is shown schematically as being part of the combustion engine 110.

If, as shown in FIG. 1, the outlets 272-276 are arranged advantageously in the area 330 of a tank bottom, the area 330 of the tank bottom 340 can be kept largely free from contaminations and deposits.

If, additionally the inlets 282-286 are arranged in the area 350 of the tank top 360, then in cooperation with the earlier described outlets 272-276, a contamination gradient can be established which increases from the area 350 of the tank top 360 to the area 330 of the tank bottom. In combination with the segmented design therefore a contamination gradient can be established which is flexible horizontally as well as vertically. It is also conceivable that an inlet location 370 is arranged in the area 380 of the middle of the tank and/or in the area 220 of the main inlet 130.

In the circulation conduit system 250 also one or several sensors may be provided by which the contamination degree of the fuel 150 can be detected. This can be achieved for example in that the circulation pump 260 is arranged during operation in an aggregate carrier 400 as shown in FIG. 2. Such an aggregate carrier 400 includes generally one or more openings 410 in which for example the circulation pump 260 can be accommodated and engaged therein so that the circulation pump 260, when installed, can be driven by the combustion engine 110.

What is claimed is:

1. A tank cleaning arrangement for cleaning liquid fuel (150) stored in a fuel tank (120) having at least one fuel outlet (270, 272, 274, 276) and at least one fuel inlet (280, 282, 286, 380), the tank cleaning arrangement including:
a fuel circulation conduit system (250) connected to the fuel tank (120) for circulating the liquid fuel (150) from the at least one outlet (270, 272, 274, 276) to the at least one inlet (280, 282, 284, 286, 380) of the tank (120), and
at least one fuel filter (300, 310) and at least one circulating pump (260) being arranged in the fuel circulating conduit system (250) for circulating the liquid fuel trough the fuel circulating conduit system including the at least one fuel filter (300, 310), the at least one circulating pump (260) being a mechanically driven pump.

2. The tank cleaning, arrangement according to claim 1, wherein at least a first fuel filter (300) is arranged in the fuel circulating conduit system (250) in flow direction (320) of the liquid fuel (150) ahead of the at least one circulating pump (260).

3. The tank cleaning arrangement according to claim 2, wherein at least a second fuel filter (310) is arranged in the circulation conduit system (250) in flow direction (320) of the fuel (150) after the at least one circulating pump (260).

4. The tank cleaning arrangement according to claim 3, wherein at least one sensor (390) is arranged in the fluid circulating system for detecting at least one of a contamination of the liquid fuel (150) and a pressure of the liquid fuel (150), the at least one sensor (390) being arranged in the flow direction of the liquid fuel in at least one of the following locations:
ahead of the at least first fuel filter (300),
after the at least first fuel filter (300),
ahead of the at least one circulating pump (260),
incorporated into the at least one circulating pump (260),
after the at least .one circulating pump (260),
ahead of the at least one second fuel filter (310),
after the at least one second fuel filter (310).

5. The tank cleaning arrangement according to claim 1, wherein the at least one outlet area (270, 272, 274, 276) is provided in the tank cleaning arrangement at one of:
an area (330) of a tank bottom (390) of the fuel tank (120),
an area (210) of the main outlet (140) of the fuel tank (120),
an area (220) of the main inlet (130) of the fuel tank (120),
an intermediate area (230) between the main outlet (210) and the main inlet area (220) of the fuel tank (120).

6. The tank cleaning arrangement according to claim 1, wherein the at least one inlet (280, 282, 284, 286, 280) is provided in the tank cleaning arrangement at one of:
the area (350) of the tank top (360) of the fuel tank (120),
an area (370) of the middle of the fuel tank (120),
an area (210) of the main outlet (140) of the fuel tank (120),
an area (220) of the main inlet (130) of the fuel tank (120),
an intermediate area (230) between the area (210) of the main outlet (140) and the area (220) of the main inlet (130).

7. A system comprising a fuel tank (120) and a tank cleaning arrangement (100) according to claim 1.

8. The system according to claim 7, wherein the fuel tank (120) is segmented including at least two tank segments (290, 292, 294, 296).

9. The system of a fuel tank and a tank cleaning arrangement according to claim 8, wherein at least one of the tank segments (290, 292, 294, 296) of the fuel tank (120) includes an outlet (270, 272, 274, 276) and an inlet (280, 282, 284, 286, 380).

10. A combustion engine with a tank cleaning arrangement (100) according to claim 1, wherein the at least one circulating pump (260) is mechanically connected to the combustion engine (110) to be operated thereby.

11. The combustion engine according to claim 10, wherein the at least one circulating pump (260) is arranged in an aggregate carrier (400) of the combustion engine (110).

12. An operating method for a tank cleaning arrangement (100) according to claim 1, wherein, during fill-up of the tank (120), the fuel (150) is circulated from an outlet (276) arranged in the area (210) of the main outlet (140) to an inlet (286) arranged in the area (210) of the main outlet (140).

13. The operating method according to claim 12, wherein, for a predetermined period after tank fill-up, the fuel (150) is circulated between an outlet (276) disposed in the area (210) of the main outlet (140) and an inlet (286, 380) arranged in the area (210) of the main outlet (140).

14. The operating method according to claim 13, wherein, after the predetermined period, the fuel (150) is circulated selectively between an outlet (276) disposed in the area (210) of the main outlet (140) or an outlet (272, 274) disposed in the intermediate area (230) or an outlet (270) disposed in the area of the main inlet (130) and an inlet (286, 380) disposed in the area of the main outlet (140).

15. The operating method according to claim 12, wherein the respective outlet (270, 272, 274, 276) and the respective inlet (280, 282, 284, 286, 380) via which the fuel (150) is being circulated is selected depending on the degree of contamination of the fuel (150) being circulated.
